(19) United States
(12) Patent Application Publication
(10) Pub. No.: US 2025/0144711 A1
(43) Pub. Date: May 8, 2025

(54) INTERMEDIATE ASSEMBLY FOR ADDITIVE MANUFACTURING

(71) Applicant: SAFRAN ADDITIVE MANUFACTURING CAMPUS, LE HAILLAN (FR)

(72) Inventor: Pierre Jean-Baptiste METGE, MOISSY-CRAMAYEL (FR)

(73) Assignee: SAFRAN ADDITIVE MANUFACTURING CAMPUS, LE HAILLAN (FR)

(21) Appl. No.: 18/837,389

(22) PCT Filed: Feb. 8, 2023
(86) PCT No.: PCT/FR2023/050171

§ 371 Date: Aug. 9, 2024

(30) Foreign Application Priority Data
Feb. 9, 2022 (FR) FR2201129

(51) Int. Cl. B22F 10/47; B22F 10/28; B22F 10/62; B33Y 10/00; B33Y 80/00

(52) U.S. Cl. CPC B22F 10/47; B22F 10/28; B22F 10/62; B33Y 10/00; B33Y 80/00

(57) ABSTRACT

An intermediate assembly for additive manufacturing includes a metal part with an overhang portion. The intermediate assembly further includes a support structure for the overhang portion, wherein the support structure includes a fusible, porous connecting portion extending from the overhang portion, a baseplate extending from the connecting portion and defining a plurality of channels, and at least one column carrying the baseplate.

### TECHNICAL FIELD OF THE INVENTION

The invention relates to an intermediate assembly for manufacturing a mechanical part by using an additive manufacturing process. The invention also relates to a method for manufacturing a part using such an intermediate assembly.

### PRIOR ART

One method known in the art consists of manufacturing at least one part, in particular one or more metal part(s), by melting successive layers of powder by means of a laser beam controlled by an information processing system in which are stored the three-dimensional coordinates of the points in the successive layers to be produced to form said parts.

FIG. 1 illustrates a manufacturing device 1 intended to implement such a method.

Manufacturing device 1 comprises a reservoir 3 containing a metal powder 5 and having a mobile bottom 7, movable in vertical translation by a rod 9 of a cylinder, and a neighboring tank 11, substantially parallelepipedal, its bottom composed of a mobile plate 13, movable in vertical translation by a rod 15 of a second cylinder.

Manufacturing device 1 further comprises a scraper 17 which allows bringing powder from reservoir 3 to tank 11, scraper 17 being movable in translation along a horizontal plane A that is substantially parallel to plate 13. Manufacturing device 1 further comprises means 18 for generating a laser beam 19, coupled to a device 20 for moving laser beam 19 which allows directing it and/or moving it to reach any point of tank 11.

To manufacture one or more parts 21, a first layer of powder is placed in tank 11, substantially in horizontal plane A, by using scraper 17.

The layer then has a down-facing surface corresponding to the surface of plate 13 and an upper surface onto which laser beam 19 is directed and moved about. The energy provided by this beam causes local fusion of the powder which, by solidifying, forms a first layer of the or of each part 21.

After formation of this first layer, plate 13 is lowered by a distance corresponding to the thickness of a layer of powder, while bottom 7 of reservoir 3 is raised by a corresponding height, so that a certain amount of powder 22 is located above horizontal plane A.

Then, this amount of powder 22 is brought by a blade 23 of scraper 17, from reservoir 3 into tank 11, to form a second layer on top of the previous layer. In the same manner as above, a second layer of each part 21 is formed using laser beam 19. The amount of powder and the positions of bottom 7 and plate 13 are determined so as to form layers of powder of a chosen and constant thickness.

These operations are repeated in a manner that stacks the layers of powder in a vertical direction Z perpendicular to horizontal plane A, and to melt targeted parts of these layers by means of laser beam 19, until the manufacture of parts 21 is complete.

This method allows complex parts to be manufactured quickly and in a fully automated manner, resulting in significant savings in time and resources.

However, it has constraints which limit the possibilities in the design of the parts.

In particular, the down-facing surfaces of parts 21 cannot form overhang angles greater than approximately 45° with the vertical direction Z in order to be manufactured using such a method.

Down-facing surfaces at a greater incline are not sufficiently supported during the stacking of powder layers, and manufacturing them requires the addition of support parts to the design model for part 21. These support parts must be manually removed after the additive manufacturing step, which requires long and dedicated machining work.

### PRESENTATION OF THE INVENTION

The invention aims to remedy these disadvantages by providing a method for the additive manufacturing of a metal part comprising overhang surfaces, without requiring machining steps after the additive manufacturing.

For this purpose, one object of the invention is an intermediate assembly for manufacturing, comprising a part, the part comprising an overhang portion, the intermediate assembly further comprising a support structure for the overhang portion,
the support structure comprising:
a fusible, porous connecting portion, extending from the overhang portion,
a baseplate extending from the connecting portion and defining a plurality of channels, and
at least one column carrying the baseplate.

Due to the support structure, such an intermediate assembly allows manufacturing a part comprising overhang portions, this support portion being easily removable afterwards by taking advantage of the step of surface treatment by chemical dissolution.

The intermediate assembly and the part are composed of a metal material.

The overhang portion comprises at least one down-facing surface forming an angle strictly greater than 45° with the vertical direction.

The connecting portion may have a porosity greater than or equal to 50%.

Recall that the porosity of a medium comprising a solid portion and an interstitial portion is defined as the ratio of the volume of the interstitial portion to the total volume.

The connecting portion may have a porosity greater than or equal to 70%.

The porosity of the connecting portion may be for example substantially equal to 75%.

Such porosity values allow significantly weakening the connecting portion during a step of surface treatment by chemical dissolution.

The baseplate comprises a plurality of pillars defining the channels between them, the mouths of the channels facing the connecting portion.

Each pillar may comprise an upper surface carrying the connecting portion, the gap separating the upper surfaces of the pillars from each other being less than 1 millimeter.

The upper surfaces of the pillars may have, for example, a hexagonal shape or a square shape.

The invention also relates to a method for manufacturing a metal part, the method comprising the following steps:
manufacture of an intermediate assembly as above, using an additive manufacturing method based on selective melting or selective sintering on a metal powder bed,
immersion of the intermediate assembly in a dissolution solution, and dissolution of an outer surface of the intermediate assembly, and
removal of the support structure by mechanical rupture of the connecting portion.

The mechanical rupture of the connecting portion may be implemented by applying a transverse force to a distal end of the column.

The transverse force is oriented substantially perpendicularly to the main direction of extension of the column.

Such a method of removal is made possible by the geometry of the support structure, and allows easy removal of the support structure, in particular manually.

Dissolution of the outer surface may be carried out to a thickness of between 0.05 millimeters and 0.2 millimeters.

Dissolution of the outer surface may reduce the mechanical strength of the connecting portion by at least 90%.

Such a characteristic allows easy removal of the support structure, in particular manually.

Mechanical strength is defined here as the value of the mechanical stress that must be exerted on the connecting portion to achieve complete rupture.

The chemical dissolution solution is in particular an acidic solution, capable of “eating” metal materials.

Such a solution allows eating slightly into the surface thickness by dissolution, which improves the surface condition of the part and weakens the connecting portion without removing too much material from the part.

### BRIEF DESCRIPTION OF FIGURES

FIG. 1 is a schematic view of an additive manufacturing device,

FIG. 2 is a front view of a part comprising an overhang portion,

FIG. 3 is a front view of an intermediate assembly according to the invention, intended for the manufacture of the part of FIG. 2, and

FIG. 4 is a detailed view of a support structure of the intermediate assembly of FIG. 3.

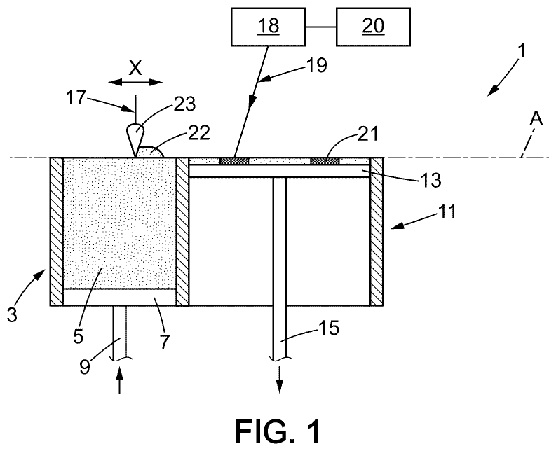

### DETAILED DESCRIPTION OF THE INVENTION

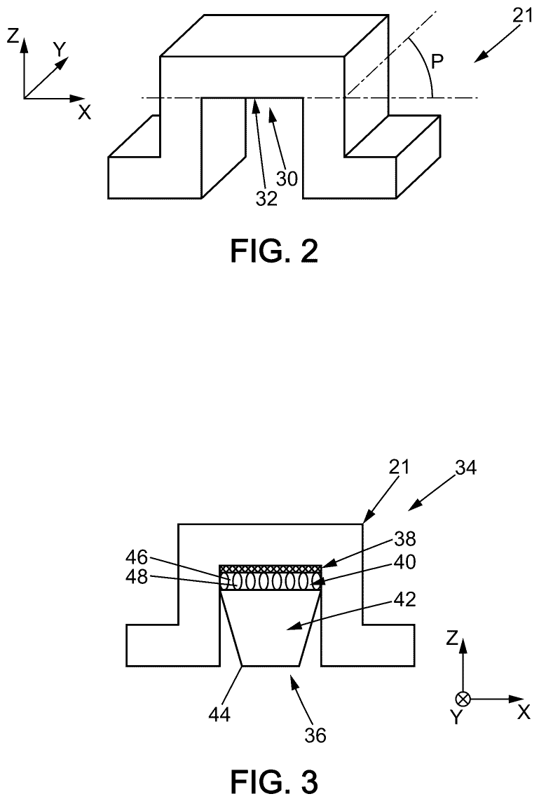

FIG. 2 represents a part 21 that we wish to manufacture by using an additive manufacturing method according to the invention.

Part 21 comprises an overhang portion 30, which has a down-facing surface 32 extending in a plane P forming an angle greater than 45° with a vertical direction Z.

In the example shown, down-facing surface 32 of overhang portion 30 extends in a substantially horizontal plane P, meaning it forms an angle of 90° with the vertical direction Z.

The vertical direction Z considered here is relative to the above additive manufacturing device 1, during an additive manufacturing step, and does not necessarily correspond to the vertical direction in the environment in which part 21 is intended to be implemented.

The method for manufacturing part 21 comprises a step of manufacturing an intermediate assembly 34, shown in FIG. 3, using an additive manufacturing method based on selective laser melting or selective sintering, as described above.

Intermediate assembly 34 is a manufacturing intermediate which comprises part 21 as well as a support structure 36 shaped to support overhang portion 30.

Support structure 36 comprises a connecting portion 38 extending from overhang portion 30, a baseplate 40 carrying connecting portion 38, and a column 42 carrying baseplate 40 and extending so that its distal end 44 rests on plate 13.

Connecting portion 38 is manufactured at the same time as the rest of intermediate assembly 34, by additive manufacturing.

Connecting portion 38 is fusible, meaning it is intended to be destroyed in order to separate support structure 36 from part 21.

Connecting portion 38 extends below the entire down-facing surface 32, so as to support it during the additive manufacturing step.

It has a high porosity, preferably greater than 50%, in particular greater than or equal to 70%.

The porosity of connecting portion 38 is for example substantially equal to 75%.

Baseplate 40 extends between connecting portion 38 and column 42, relative to the vertical direction Z, so as to support connecting portion 38.

Baseplate 40 comprises a plurality of pillars 46 having flared shapes, defining fluid circulation channels 48 between them.

Column 42 is dense and extends substantially in the vertical direction Z, from baseplate 40 to its distal end 44 intended to be in contact with plate 13 during manufacturing.

In the example shown, column 42 has a shape which becomes gradually slimmer from baseplate 40 to distal end 44, while maintaining side surfaces forming angles of less than 45° with the vertical direction Z, and preferably less than 30°. This shape allows reducing the amount of material required to manufacture column 42 and facilitates gripping it, without imposing constraints on the manufacturability of intermediate assembly 32.

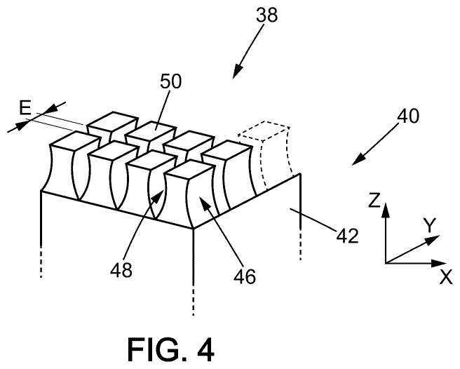

FIG. 4 is a detailed view showing baseplate 40 and the upper part of column 42.

As shown, each pillar 46 comprises an upper end 50, facing away from column 42 relative to the vertical direction Z. Said upper end 50 forms a flat surface carrying connecting portion 38.

Each upper end 50 has a substantially square shape in a horizontal plane.

Alternatively, the upper ends may have rectangular or hexagonal shapes.

A spacing E between upper ends 50 of each pillar 46 is less than or equal to 1 mm, in order to allow the manufacturing of connecting portion 38 over baseplate 40.

The mouths of channels 48 defined between pillars 46 open onto the entire down-facing surface of connecting portion 38, between upper ends 50, which makes it possible to place the entire connecting portion in contact with the liquid circulating in channels 48.

The method for manufacturing part 21 comprises, after the additive manufacturing step, a step of immersing intermediate assembly 34 in a dissolution solution.

The chemical dissolution solution is for example an acidic solution, capable of “eating” metal materials.

Intermediate assembly 34 is immersed in the bath of dissolution solution for an immersion duration of between 15 minutes and 1 hour, preferably between 15 and 45 minutes.

The dissolution solution flows into channels 48 and permeates the entire connecting portion 38.

During the immersion step, some of the thickness of the outer surface of the intermediate assembly 32 is dissolved by the dissolution solution. The dissolution thickness is in particular between 0.05 millimeters and 0.2 millimeters.

Such a step of immersion and surface dissolution is conventional in additive manufacturing methods based on selective powder bed fusion, and allows improving the surface condition of the manufactured parts.

Here, this step also allows significantly weakening connecting portion 38, since its high porosity makes the dissolution thickness non-negligible relative to its structure.

Connecting portion 38, for example, loses at least 90% of its mechanical strength during the step of immersion and surface dissolution.

The method then comprises a step of removing support structure 36, during which a transverse force, meaning oriented in a direction within a horizontal plane, is applied to distal end 44 of column 42.

This transverse force, applied manually or by means of a tool depending on the dimensions involved, allows the mechanical rupture of connecting portion 38 and the removal of support structure 36.

The invention may be generalized to any part having an overhang portion 30 in which down-facing surface 32 forms an angle greater than 45° with the vertical direction Z, changing the shape of column 42 and/or the orientation of baseplate 40 so as to have suitable support during the additive manufacturing step.

1. An intermediate assembly for additive manufacturing, comprising a metal part, the part comprising an overhang portion, the intermediate assembly further comprising a support structure for the overhang portion,
the support structure comprising:
a fusible, porous connecting portion extending from the overhang portion,
a baseplate extending from the connecting portion and defining a plurality of channels, and
at least one column carrying the baseplate, the column being dense,
wherein the baseplate comprises a plurality of pillars defining the channels therebetween, each of the plurality of channels having a mouth facing the connecting portion.

2. The intermediate assembly according to claim 1, wherein the connecting portion has a porosity greater than or equal to 50%.

3. The intermediate assembly according to claim 2, wherein the connecting portion has a porosity greater than or equal to 70%.

4. The intermediate assembly according to claim 3, wherein each pillar comprises an upper end carrying the connecting portion, a gap separating the upper ends of the pillars from each other being less than 1 millimeter.

5. A method for manufacturing a metal part, the method comprising the following steps:
manufacturing the intermediate assembly according to claim 1 using an additive manufacturing method based on selective melting or selective sintering on a metal powder bed,
immersing the intermediate assembly in a dissolution solution, and dissolution of dissolving an outer surface of the intermediate assembly, and
removing the support structure by mechanical rupture of the connecting portion.

6. The method according to claim 5, wherein the mechanical rupture of the connecting portion is implemented by applying a transverse force to a distal end of the column.

7. The method according to claim 5, wherein dissolution of the outer surface is carried out to a thickness of between 0.05 millimeter and 0.2 millimeter.

8. The method according to claim 5, wherein dissolution of the outer surface reduces the mechanical strength of the connecting portion by at least 90%.
